(19) United States
(12) Patent Application Publication
(10) Pub. No.: US 2010/0138399 A1
(43) Pub. Date: Jun. 3, 2010

(54) METHOD FOR DATA ENCRYPTION AND METHOD FOR DATA SEARCH USING CONJUNCTIVE KEYWORD

(75) Inventors: Namsu JHO, Seoul (KR); Dowon HONG, Daejeon (KR); Hyunsook CHO, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/576,537

(22) Filed: Oct. 9, 2009

(30) Foreign Application Priority Data
Dec. 1, 2008 (KR) 10-2008-0120412

(51) Int. Cl. G06F 17/30

(52) U.S. Cl. 707/696; 707/E17.014; 707/697

(57) ABSTRACT

The present invention relates to a method for data encryption and a method for data search using a conjunctive keyword and more particularly to, a method for searching data stored in a server by using a conjunctive keyword after storing an index table for the conjunctive keyword and encrypted data in the server. According to an embodiment of the present invention, since keywords and relevant data do not need to be searched one by one by performing a conjunctive keyword search by using a linked tree structure modifying a linked list, it is possible to perform a rapid and efficient conjunctive keyword search.

### RELATED APPLICATIONS

The present application claims priority to Korean Patent Application Serial Number 10-2008-0120412, filed on Dec. 1, 2008, the entirety of which is hereby incorporated by reference.

### BACKGROUND OF THE INVENTION

1. Field of the Invention

The present invention relates to a method for data encryption and a method for data search using a conjunctive keyword, and more particularly, to a method for data encryption and a method for data search using a conjunctive keyword that can efficiently search data.

2. Description of the Related Art

A modern society is changed into a society that digitalizes and stores all information and shares the stored information through a network. Further, due to the increase in the amount of processed data and a demand for various services increases, various specialized external storage means are being extensively utilized. Moreover, a security of information stored in the external storage means becomes an issue.

The security of the external storage means has a difference from a security when an individual managed information by himself/herself by using an independent storage space. The reason for this is that an information owner is fundamentally different from a subject which manages the external storage means. An access control technique or a key management technique which is principally used to protect the information in a database is effective in preventing an external intruder, but the techniques cannot fundamentally prevent a manager of the external storage means from reading data stored in the corresponding storage means.

For this, data encryption may be used as a method for safely storing the information. That is, information to be stored in the external storage means is encrypted by using an encryption system proven to be secure. The encryption system having the probed safety ensures that an attacker who does not own a decryption key cannot acquire stored information from encrypted data. As a result, although the external intruder or the manger of the external storage means accesses the encrypted data, the external intruder or the manager of the external storage means cannot acquire detailed information from the corresponding data.

Meanwhile, encryption of information is a method for perfectly securing the confidentiality of stored information, but the information encryption also disables many additional functions provided from the general database to be used. That is, as the amount of the stored information increase, various database functions are required to efficiently utilize and manage the stored information. Therefore, a method for simply encrypting and storing the information is not applicable.

A searchable encryption technology is contrived to search data including a predetermined keyword while securing the confidentiality of the encrypted information like the general encryption technology. Since most of the various functions provided from the database are based on search of the information including the predetermined keyword, the searchable encryption system is considered as one of the solutions to the above-mentioned problems.

In the searchable encryption system, data is searched by the keyword unit. That is, a trapdoor is created on the basis of a predetermined keyword and a user's secret key and data including the predetermined keyword are searched by using the trapdoor. The search is performed by a server and the server determines whether or not predetermined data acquired through calculation using a stored encrypted index and the trapdoor includes the corresponding keyword.

A representative example may include a search for a conjunctive keyword. In the known conjunctive keyword search, data including several keywords at the same time is searched. An example of searching data including keywords A and B at the same time will be described below. When searches using a single keyword A and a single keyword B are performed, the server acquires a set S(A) of all data including the keyword A and a set S(B) of all data including the keyword B and lastly finds data including both the keyword A and the keyword B by calculating S(A)∩S(B).

However, although a user can acquire a desired result through the calculation, more information outflows to the server during the search. That is, the server finds that the user performs the searches for the two keywords, and S(A) and S(B) are results of the searches. Therefore, this method cannot fundamentally solve a problem in that user's information is opened to the server.

Further, a study of the conjunctive keyword search has been performed in only the searchable encryption system of an open-key scheme up to now. However, since many calculations are required for the encryption, the creation of the trapdoor, and the search due to features of the open-key scheme, efficiency is deteriorated.

### SUMMARY OF THE INVENTION

A first object of the present invention is to provide a method for data encryption and a method for data search using a conjunctive keyword that can perform an efficient conjunctive keyword search by using a linked tree structure acquired by modifying a linked list.

A second object of the present invention is to provide a method for data encryption and a method for data search using a conjunctive keyword that can search only data satisfying search keywords at the same time by generating an index table for the conjunctive keyword in addition to a plurality of keywords.

A third object of the present invention is to provide a method for data encryption and a method for data search using a conjunctive keyword that can encrypt data by using the conjunctive keyword in a symmetric key type encryption system.

In order to achieve the above-mentioned objects, a method for data encryption using a conjunctive keyword in a portable terminal according to an aspect of the present invention includes: creating a secret key for data encryption and selecting a one-way function for creating an index table; combining a plurality of keywords by extracting the plurality of keywords from a corresponding data and configuring the conjunctive keyword from each keyword combination; allocating the conjunctive keyword in configuring the conjunctive keyword to correspond to a plurality of indexes; encrypting each conjunctive keyword and an index to which the corresponding conjunctive keyword is allocated by the one-way function selected in selecting the one-way function and creating an index table of the encrypted conjunctive keyword; and encrypting each data by using the secret key created in selecting the one-way function.

In selecting the one-way function, two one-way functions are selected. At this time, the two one-way functions are a one-way function for encrypting the conjunctive keyword and the other one-way function for encrypting each index to which the conjunctive keyword is allocated.

The keyword combination corresponds to all partial sets which can be combined from each of the plurality of keywords.

Further, the method for data encryption further includes, before allocating the conjunctive keyword, creating the plurality of indexes. In creating the indexes, 2^{t} indexes are created for t keywords. Herein, t is a predetermined positive integer.

The indexes include at least one of a data identifier, a linkage, and a constant. At this time, the constant as a discriminator for verifying whether or not the conjunctive keyword is allocated to the corresponding index, has a value of ‘0’ or ‘1’.

Further, in creating the index table, a linkage value is set for an index including at least one common keyword among the conjunctive keywords allocated to each index. At this time, a linkage value is set for a conjunctive keyword that includes at least one common keyword and in which the number of combined keywords is more than the number of common keyword by one and the linkage value of each index includes an address value of the corresponding index and a decryption value of the corresponding index.

In the index table, each index has a linked tree structure by the linkage value set to the index.

Meanwhile, in order to achieve the above-mentioned objects, a method for data search using a conjunctive keyword according to another aspect of the present invention includes: receiving a trapdoor for a search keyword to which a plurality of keywords are combined from the user terminal; extracting an index corresponding to the received trapdoor from the index table created for the conjunctive keyword of the data; decrypting the extracted index by using the trapdoor; adding a data identifier of the decrypted index to a data search list and performing the data search by extracting a next index from a linkage value of the extracted index; and transmitting the data search list to the user terminal after the data search using the index table is completed.

Meanwhile, the method for data search using a conjunctive keyword further includes, before receiving the trapdoor, receiving and storing the index table for the encrypted data from the user terminal and the index table for the conjunctive keyword of the encrypted data. At this time, each index of the index table includes at least one of a data identifier, a linkage, and a constant.

The trapdoor includes a conjunctive search keyword encrypted by a one-way function used for encrypting a conjunctive keyword and a hash value encrypted by a one-way function used for encrypting the index in creating the index.

In performing the data search, the data search is performed by a linked tree structure from a linkage value of the corresponding index. Further, in performing the data search, the data search is continuously performed until the linkage value of the corresponding index becomes ‘EMPTY’. In addition, performing the data search includes determining whether or not the corresponding index is an index to which the conjunctive keyword is allocated from a value of a constant included in the corresponding index.

Meanwhile, the method for data search using a conjunctive keyword further includes terminating performing the data search and transmitting an error message to the corresponding user terminal when it is determined that the conjunctive keyword is not allocated to the corresponding index.

Further, the method for data search using a conjunctive keyword further includes, after transmitting the error message, extracting and transmitting a corresponding data to the corresponding user terminal when the user terminal requests data selected from the data search list.

According to an embodiment of the present invention, since relevant data do not need to be searched one by one by performing a conjunctive keyword search by using a linked tree structure modifying a linked list, it is possible to perform a rapid and efficient conjunctive keyword search.

Further, according to an embodiment of the present invention, an index table is created with respect to the conjunctive keyword in addition to a plurality of keywords. Accordingly, a server does not perform a search for each keyword, but searches only data satisfying keywords at the same time from the index table without knowing contents of the data or the keyword, thereby secure the confidentiality of user's important data.

In addition, according to an embodiment of the present invention, the data is encrypted by using the conjunctive keyword in a symmetric key type encryption system, such that it is possible to shorten a calculation time while searching the encrypted data.

### BRIEF DESCRIPTION OF THE DRAWINGS

FIG. 1 is a flowchart illustrating an operational flow of a method for data encryption according to an embodiment of the present invention;

FIG. 2 is a flowchart illustrating an operational flow of a method for data search according to an embodiment of the present invention;

FIGS. 3A and 3B are exemplary diagrams illustrating structures of data and an index table adopted according to an embodiment of the present invention;

FIG. 4 is an exemplary diagram illustrating a detailed structure of an index according to an embodiment of the present invention;

FIGS. 5 to 7 are exemplary diagrams referenced for describing an operation of creating an index table according to an embodiment of the present invention; and

FIG. 8 is an exemplary diagram illustrating a structure of a linked tree according to an embodiment of the present invention.

### DETAILED DESCRIPTION OF THE PREFERRED EMBODIMENTS

Hereinafter, embodiments of the present invention will be described with reference to the accompanying drawings.

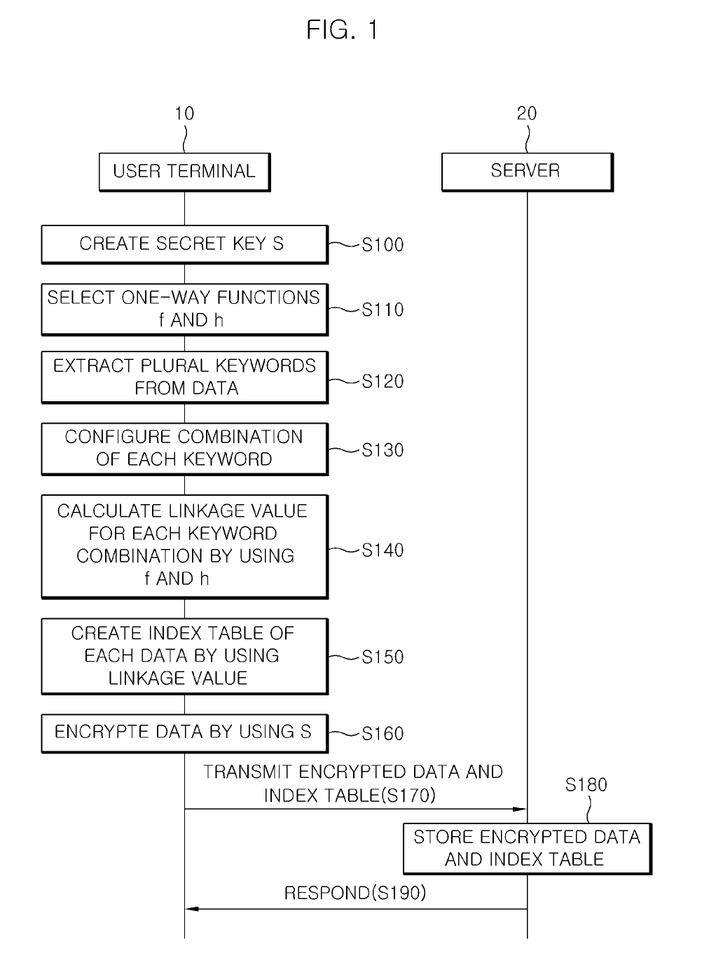

FIG. 1 is a flowchart illustrating an operational flow of a method for data encryption according to an embodiment of the present invention. Referring to FIG. 1, a user terminal 10 first creates a secret key S for encrypting data. Further, the user terminal 10 selects one-way functions f and h for creating indexes of data.

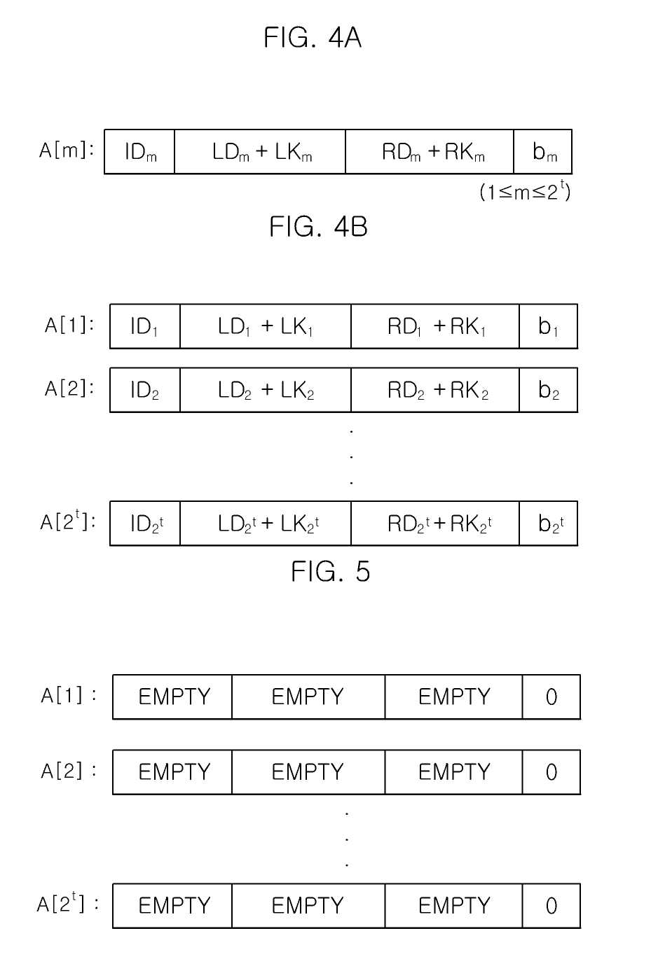

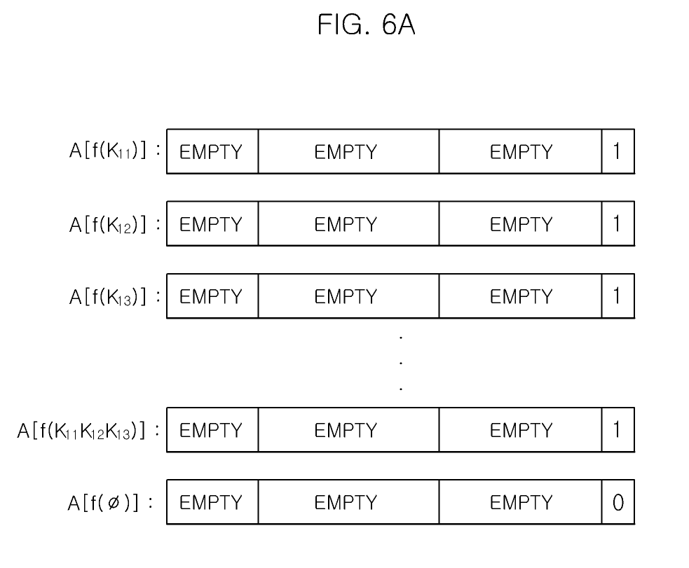

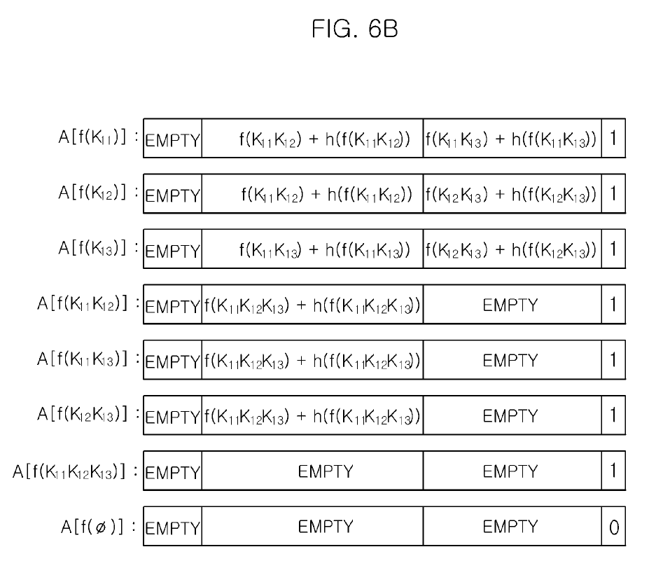

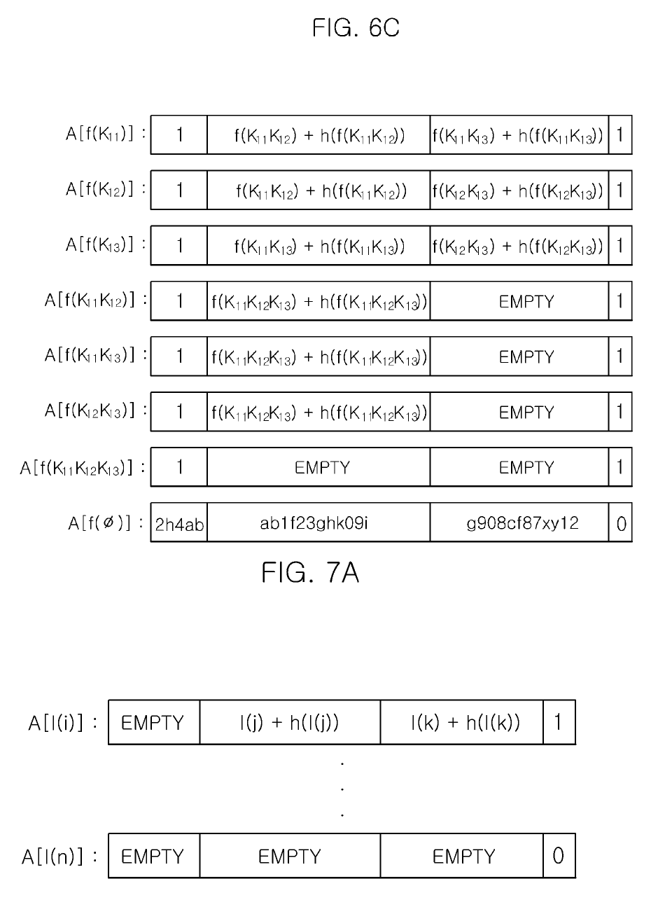

Further, the user terminal 10 extracts a plurality of keywords from each data and configures a combination of the keywords. That is, the user terminal 10 configures all partial sets for the plurality of keywords that are extracted from the corresponding data. The user terminal 10 creates an index for each keyword combination by using the one-way functions f and h selected at step ‘S110’. At this time, each keyword combination has a linked tree structure. The detailed embodiment thereof will be described with reference to FIGS. 4 and 6C.

The user terminal 10 encrypts data by using the secret key S created at step ‘S100’ and transmits the secret key S to a server 20 in addition to the index created at step ‘S150’.

When the server 20 receives encrypted data and indexes from the user terminal 10, the server 20 stores the received encrypted data and indexes. At this time, since the server 20 stores only the encrypted data and indexes, the server 20 cannot grasp the content of each data and an external user cannot also verify the content of the data stored in the server 20, thereby preventing personal information from being leaked to the outside.

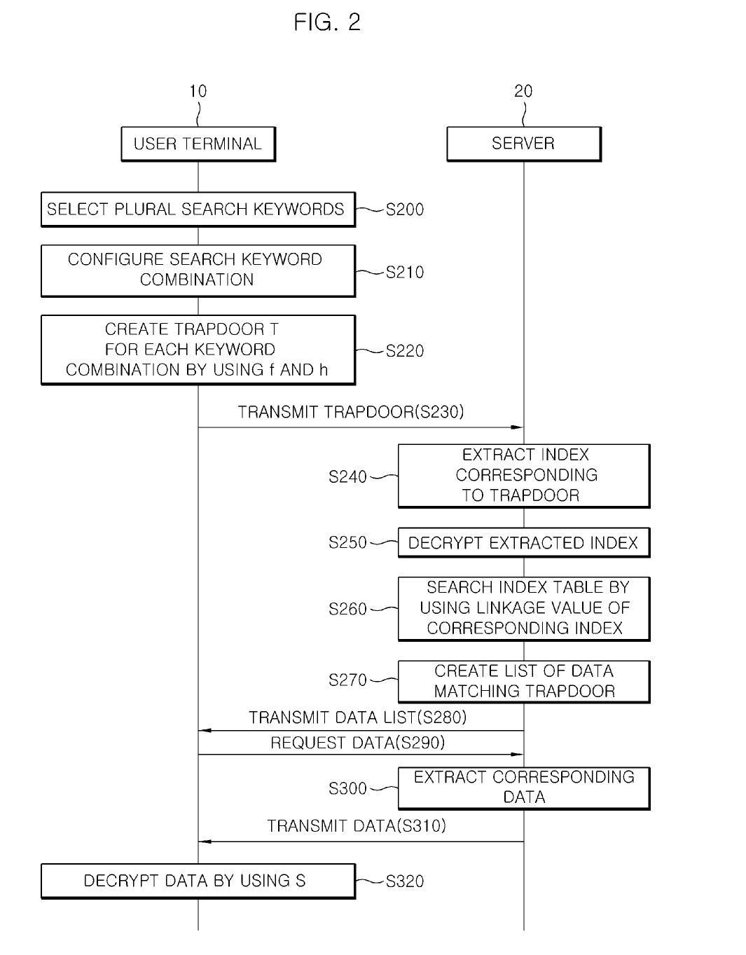

FIG. 2 is a flowchart illustrating an operational flow of a method for data search according to an embodiment of the present invention and more particularly, relates to a method for searching data by using a conjunctive keyword.

Referring to FIG. 2, the user terminal 10 first selects a plurality of search keywords for searching the data stored in the server 20. Further, the user terminal 10 configures a combination of the plurality of search keywords selected at step ‘S200’. At this time, the user terminal 10 configures all partial sets for the plurality of search keywords.

The user terminal 10 creates a trapdoor for each search keyword combination by using the one-way functions f and h which are used to create the index at step ‘S140’ of FIG. 1 and requests data including the search keywords by transmitting the created trapdoor to the server 20.

When the server 20 receives the trapdoor from the user terminal 10, the server 20 performs a conjunctive keyword search by using the linked tree structure of the index. Herein, the trapdoor includes a key for searching an index table and a secret key for decrypting the corresponding index.

At this time, the user terminal 10 extracts the corresponding index by using the trapdoor received from the user terminal 10 and decrypts the extracted index by using the secret key of the trapdoor. Further, the user terminal 10 searches the index table by using a linkage value of the decrypted index. At this time, the user terminal 10 detects and decrypts an index which matches the trapdoor. The user terminal 100 extracts data which matches the corresponding door from the decrypted index and transmits the data to the user terminal 10.

As a result, the user terminal 10 decrypts the data transmitted from the server 20 by using the secret key S at step ‘S160’ of FIG. 1 and outputs the data.

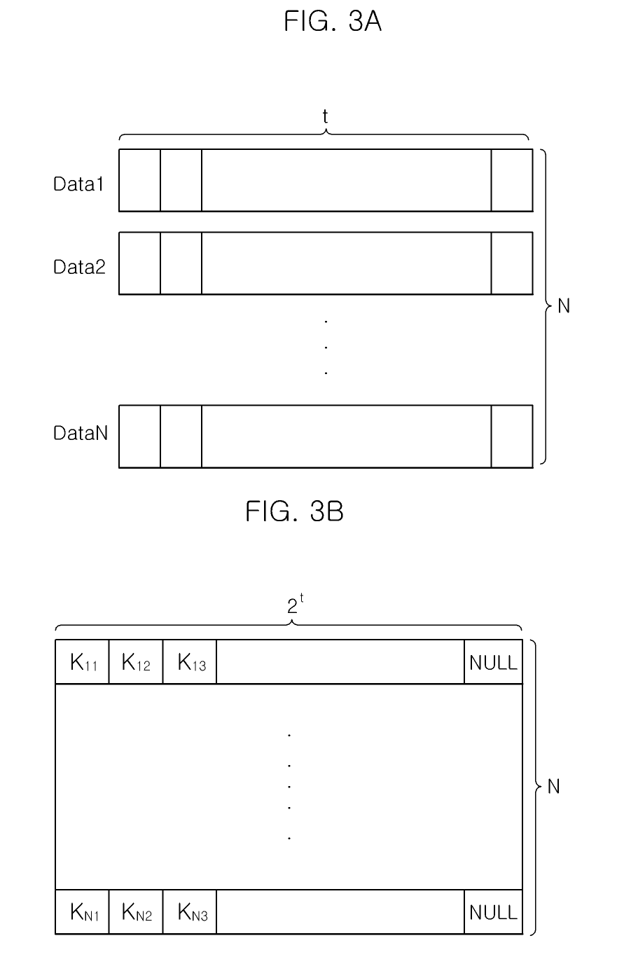

FIG. 3A is a schematic diagram illustrating a structure of data according to an embodiment of the present invention and FIG. 3B is a schematic diagram illustrating a structure of an index table according to an embodiment of the present invention.

The embodiment will be described below with reference to FIGS. 3A and 3B. First, the user terminal 10 stores total N data and each data has t keywords. At this time, the user terminal 10 combines keywords of the data and creates an index table for each keyword combination. For example, assumed that i is a predetermined integer among 1 to N, when keywords of data i are Kᵢ₁, Kᵢ₂, and Kᵢ₃, combinations of the keywords are [Kᵢ₁], [Kᵢ₂], [Kᵢ₃], [Kᵢ₁Kᵢ₂], [Kᵢ₁Kᵢ₃], [Kᵢ₂Kᵢ₃], and [Kᵢ₁Kᵢ₂Kᵢ₃].

Herein, the index table of each data has 2^{t} indexes. If the number of keywords of the corresponding data is 3, the index table of the corresponding data is 2³, such that the index table has 8 indexes. Further, since each of N data has the index table, the index table has total 2^{t}×N indexes.

The combinations of the keywords correspond to the index tables of the corresponding data, respectively. If the number of the indexes of the corresponding data is larger than the number of the combinations of the keywords, remaining indexes are expressed as ‘NULL’.

FIGS. 4 to 6C are diagrams referenced for describing an operation of creating an index table according to an embodiment of the present invention.

First, in FIG. 4, (a) illustrates a structure of elements included in each index of the index table. Assumed that m is a predetermined integer among 1 to 2^{t}, when the elements included in each index are A[m], the index table has a structure of A[m]={IDₘ, (LDₘ,LKₘ), (RDₘ,RKₘ), bₘ}.

Herein, IDₘ is an identifier for discriminating data to which the corresponding index belongs. At this time, IDₘ has any one value among 1 to N, that is, values corresponding to N data. Further, (LDₘ,LKₘ) and (RDₘ,RKₘ) are linkage values for forming the linked tree structure of the index table. A detailed embodiment thereof will be described with reference to FIG. 6B. Meanwhile, bₘ, as a constant value for determining whether or not keyword information is included in the corresponding index, has a value of ‘0’ or ‘1’. Thereafter, the server 20 determines whether or not the keyword is included in the corresponding index from the value of bₘ at the time of searching the keyword.

In FIG. 4, (b) illustrates a configuration of each index for one data with reference to the structure of the elements of (a). In other words, since the corresponding data has total 2^{t} indexes, elements included in the indexes are A[1], A[2], . . . , A[2^{t}]. At this time, the index table has a structure of A[1]={ID₁, (LD₁,LK₁), (RD₁,RK₁), b₁}, A[2]={ID₂, (LD₂,LK₂), (RD₂,RK₂), b₂}, . . . , A[2^{t}]={ID₂_{^{t}}, (LD₂_{^{t}}, LK₂_{^{t}}), (RD₂_{^{t}}, RK₂_{^{t}}), b₂_{^{t}}}.

Therefore, an operation of creating the index table will now be described in more detail with reference to the index configuration of FIG. 4. First, FIG. 5 illustrates an initialization state of each index for the index table of the data. As shown in FIG. 5, IDₘ, (LDₘ,LKₘ), and (RDₘ,RKₘ) of the elements A[m] are expressed as ‘EMPTY’ in the initialization state and bₘ is initialized to ‘0’.

Assumed that a set of the keywords of Data i is Sᵢ, Sᵢ={Kᵢ₁, Kᵢ₂, . . . , Kᵢₜ}. Herein, if ‘t>3’ and Sᵢ={Kᵢ₁, Kᵢ₂, Kᵢ₃}, Sᵢ may be defined as Sᵢ={Kᵢ₁, Kᵢ₂}={Kᵢ₁, Kᵢ₂, *, . . . , *} in order to adjust the number of total t keywords. Further, assumed that a set having a partial set of Sᵢ as an element is S, S=[{Kᵢ₁}, {Kᵢ₂}, {Kᵢ₃}, {Kᵢ₁Kᵢ₂}, {Kᵢ₁Kᵢ₃}, {Kᵢ₂Kᵢ₃}, {Kᵢ₁Kᵢ₂Kᵢ₃}]. That is, S has at least one keyword combination included in Dᵢ as an element.

FIG. 6A illustrates an operation of allocating each keyword combination of the data to each index. If any one keyword combination is allocated to each index, a set value of bₘ of the index A[m] to which the keyword combination is allocated is changed from ‘0’ to ‘1’.

At this time, the user terminal 10 calculates a value of I(i) that are defined as I(i)=f(Kᵢ₁∥Kᵢ₂∥ . . . ∥Kᵢₜ) and changes a value of b_{I(i)} of an index A[I(i)] corresponding to the calculated I(i) to ‘1’. In other words, if Sᵢ={Kᵢ₁, Kᵢ₂, Kᵢ₃}, the elements of S=[{Kᵢ₁}, {Kᵢ₂}, {Kᵢ₃}, {Kᵢ₁Kᵢ₂}, {Kᵢ₁Kᵢ₃}, {Kᵢ₂Kᵢ₃}, {Kᵢ₁Kᵢ₂Kᵢ₃}] defined above are allocated to corresponding indexes A[m], respectively and the value of bₘ of the corresponding A[m] is changed to ‘1’.

For example, if a set of keywords of Data1 is S₁={K₁₁, K₁₂, K₁₃}, S=[{K₁₁}, {K₁₂}, {K₁₃}, {K₁₁K₁₂}, {K₁₁K₁₃}, {K₁₂K₁₃}, {K₁₁K₁₂K₁₃}]. At this time, I(1)={f(K₁₁), f(K₁₂), f(K₁₃), f(K₁₁K₁₂), f(K₁₁K₁₃), f(K₁₂K₁₃), f(K₁₁K₁₂K₁₃)}. Therefore, all values of b of indexes A[f(K₁₁)], A[f(K₁₂)], A[f(K₁₃)], A[f(K₁₁K₁₂)], A[f(K₁₁K₁₃)], A[f(K₁₂K₁₃)], and A[f(K₁₁K₁₂K₁₃)] corresponding to I(1) are changed to ‘1’. Meanwhile, a set value of an index A[f(φ)] having no corresponding keyword combination has ‘0’ which is an initial value as it is.

Meanwhile, FIG. 6B illustrates an operation of setting a linkage value with respect to the keyword combination allocated to each index in FIG. 6A.

First, the user terminal 10 extracts all pairs of (Sₚ, S_{q}) that satisfy Sₚ⊂S_{q} and |Sₚ|+1=|S_{q}| among elements included in S. At this time, a linkage, which is connected from an index A[I(p)] corresponding to the extracted Sₚ to an index A[I(q)] corresponding to S_{q}, is established. That is, any one of LD_{I(p)} and RD_{I(p)} which are linkage values of A[I(p)] is set as the value of I(q) and LK_{I(p)} or RK_{I(p)} corresponding to I(q) is set as a value of h(I(q)). Therefore, A[I(p)] and A[I(q)] have the linked tree structure.

Referring to FIG. 6B, assumed that Sₚ and S_{q} are the elements of S in S=[{K₁₁}, {K₁₂}, {K₁₃}, {K₁₁K₁₂}, {K₁₁K₁₃}, {K₁₂K₁₃}, {K₁₁K₁₂K₁₃}], pairs of (Sₚ, S_{q}) that satisfy Sₚ⊂S_{q} and |Sₚ|+1=|S_{q}| are (K₁₁, K₁₁K₁₂), (K₁₁, K₁₁K₁₃), (K₁₂, K₁₁K₁₂), (K₁₂, K₁₂K₁₃), (K₁₃, K₁₁K₁₃), (K₁₃, K₁₂K₁₃), (K₁₁K₁₂, K₁₁K₁₂K₁₃), (K₁₁K₁₃, K₁₁K₁₂K₁₃), and (K₁₂K₁₃, K₁₁K₁₂K₁₃).

First, I(p)=f(K₁₁) and I(q)=f(K₁₁K₁₂) from (K₁₁, K₁₁K₁₂). Therefore, any one of LD and RD which are linkage values of A[f(K₁₁)] having the value of ‘EMPTY’, i.e., LD is set to f(K₁₁K₁₂) which is a value of I(q). At this time, LK corresponding to LD is set to h(I(q)), i.e., h(f(K₁₁K₁₂)). Further, I(p)=f(K₁₁) and I(q)=f(K₁₁K₁₃) from (K₁₁, K₁₁K₁₃). At this time, any one of LD and RD which are the linkage values of A[f(K₁₁)] having the value of ‘EMPTY’, i.e., RD is set to f(K₁₁K₁₃) which is a value of I(q). At this time, RK corresponding to RD is set to h(I(q)), i.e., h(f(K₁₁K₁₃)).

Therefore, referring to FIG. 6B, an index A[f(K₁₁)] corresponding to K₁₁ is defined as EMPTY, (f(K₁₁K₁₂), h(f(K₁₁K₁₂))), (f(K₁₁K₁₃), h(f(K₁₁K₁₃))), and 1.

Meanwhile, I(p)=f(K₁₂) and I(q)=f(K₁₁K₁₂) from (K₁₂, K₁₁K₁₂). Therefore, any one of LD and RD which are linkage values of A[f(K₁₂)] having the value of ‘EMPTY’, i.e., LD is set to f(K₁₁K₁₂) which is the value of I(q). At this time, LK corresponding to LD is set to h(I(q)), i.e., h(f(K₁₁K₁₂)). Further, I(p)=f(K₁₂) and I(q)=f(K₁₂K₁₃) from (K₁₂, K₁₂K₁₃). At this time, any one of LD and RD which are the linkage values of A[f(K₁₂)] having the value of ‘EMPTY’, i.e., RD is set to f(K₁₂K₁₃) which is a value of I(q). At this time, RK corresponding to RD is set to h(I(q)), i.e., h(f(K₁₂K₁₃)).

Therefore, referring to FIG. 6B, an index A[f(K₁₂)] corresponding to K₁₂ is defined as EMPTY, (f(K₁₁K₁₂), h(f(K₁₁K₁₂))), (f(K₁₂K₁₃), h(f(K₁₂K₁₃))), and 1.

Meanwhile, A[f(K₁₁K₁₂)] which is connected to the linkage values of A[f(K₁₁)] and A[f(K₁₂)] becomes I(p)=f(K₁₁K₁₂) and I(q)=f(K₁₁K₁₂K₁₃) from (K₁₁K₁₂, K₁₁K₁₂K₁₃). Therefore, any one of LD and RD which are linkage values of A[f(K₁₁K₁₂)] having the value of ‘EMPTY’, i.e., LD is set to f(K₁₁K₁₂K₁₃) which is a value of I(q). At this time, LK corresponding to LD is set to h(I(q)), i.e., h(f(K₁₁K₁₂K₁₃)). Since the pair of I(p)=f(K₁₁K₁₂) is not provided any longer, referring to FIG. 6B, an index A[f(K₁₁K₁₂)] corresponding to K₁₁K₁₂ is defined as EMPTY, (f(K₁₁K₁₂K₁₃), h(f(K₁₁K₁₂K₁₃))), EMPTY, and 1.

Further, A[f(K₁₁K₁₃)] which is connected to the linkage values of A[f(K₁₁)] becomes I(p)=f(K₁₁K₁₃) and I(q)=f(K₁₁K₁₂K₁₃) from (K₁₁K₁₃, K₁₁K₁₂K₁₃). Therefore, any one of LD and RD which are linkage values of A[f(K₁₁K₁₃)] having the value of ‘EMPTY’, i.e., LD is set to f(K₁₁K₁₂K₁₃) which is a value of I(q). At this time, LK corresponding to LD is set to h(I(q)), i.e., h(f(K₁₁K₁₂K₁₃)). Since the pair of I(p)=f(K₁₁K₁₃) is not provided any longer, referring to FIG. 6B, an index A[f(K₁₁K₁₃)] corresponding to K₁₁K₁₃ is defined as EMPTY, (f(K₁₁K₁₂K₁₃), h(f(K₁₁K₁₂K₁₃))), EMPTY, and 1.

Similarly, A[f(K₁₂K₁₃)] which is connected to linkage values of A[f(K₁₂)] becomes I(p)=f(K₁₂K₁₃) and I(q)=f(K₁₁K₁₂K₁₃) from (K₁₂K₁₃, K₁₁K₁₂K₁₃). Therefore, any one of LD and RD which are linkage values of A[f(K₁₂K₁₃)] having the value of ‘EMPTY’, i.e., LD is set to f(K₁₁K₁₂K₁₃) which is the value of I(q). At this time, LK corresponding to LD is set to h(I(q)), i.e., h(f(K₁₁K₁₂K₁₃)). Since the pair of I(p)=f(K₁₂K₁₃) is not provided any longer, referring to FIG. 6B, an index A[f(K₁₂K₁₃)] corresponding to K₁₂K₁₃ is defined as EMPTY, (f(K₁₁K₁₂K₁₃), h(f(K₁₁K₁₂K₁₃))), EMPTY, and 1.

Meanwhile, since A[f(K₁₁K₁₂K₁₃)] which is connected to linkage values of A[f(K₁₁K₁₂)], A[f(K₁₁K₁₃)] and A[f(K₁₂K₁₃)] has no pair of I(p)=f(K₁₁K₁₂K₁₃), referring to FIG. 6B, the index A[f(K₁₁K₁₂K₁₃)] corresponding to K₁₁K₁₂K₁₃ is defined as EMPTY, EMPTY, EMPTY, and 1.

Therefore, by the process, in the case of the user terminal 10, all indexes A[f(K₁₁)], A[f(K₁₂)], A[f(K₁₃)], A[f(K₁₁K₁₂)], A[f(K₁₁K₁₃)], A[f(K₁₂K₁₃)], and A[f(K₁₁K₁₂K₁₃)] of Data1 can be defined as shown in FIG. 6B.

FIG. 6C illustrates a last process of creating the index table of the corresponding data and illustrates an operation of allocating a data identifier to each index defined in FIGS. 6A and 6B. As described above, the data identifier has a value corresponding to data among 1 to N. For example, ID₁ which is a data identifier for the index of Data1 can be set to 1. That is, as shown in FIG. 6C, a value of ID can be set to ‘1’ for indexes A[f(K₁₁)], A[f(K₁₂)], A[f(K₁₃)], A[f(K₁₁K₁₂)], A[f(K₁₁K₁₃)], A[f(K₁₂K₁₃)], and A[f(K₁₁K₁₂K₁₃)] of DATA1.

Meanwhile, all values of ID, (LD, LK), and (RD, RK) except for a value of b are filled with an arbitrarily selected random sequence with respect to the index A[f(φ)] to which the keyword combination is not allocated in the index tables of Data1.

Lastly, the user terminal 10 completes the index table for Data1 as shown in 6C by encrypting the indexes A[I(i)] by using h(I(i)). In other words, in FIG. 6C, A[f(K₁₁)] is encrypted by h(f(K₁₁)), A[f(K₁₂)] is encrypted by h[f(K₁₂)], and A[f(K₁₃)] is encrypted by h(f(K₁₃)). Further, A[f(K₁₁K₁₂)] is encrypted by h(f(K₁₁K₁₂)), A[f(K₁₁K₁₃)] is encrypted by h(f(K₁₁K₁₃)), and A[f(K₁₂K₁₃)] is encrypted by h(f(K₁₂K₁₃)). Further, A[f(K₁₁K₁₂K₁₃)] is encrypted by h(f(K₁₁K₁₂K₁₃)).

Similarly, the user terminal 10 completes the index table for all data by creating the index table through the processes of FIGS. 6A to 6C even with respect to Data 2 to Data N.

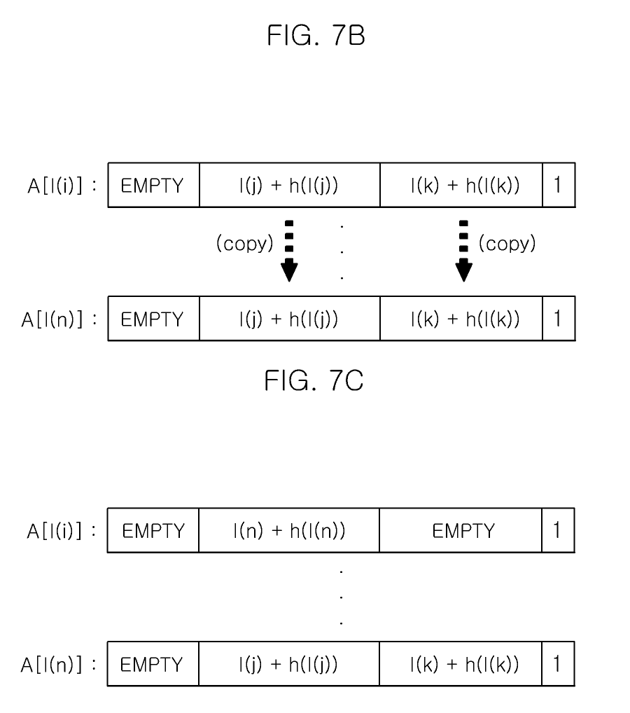

Meanwhile, FIGS. 7A to 7C illustrates another embodiment of FIG. 6B and illustrates an embodiment when linkage values are added by extending the index.

In the above-mentioned embodiment, two linkage values can be added to one index. If a linkage value corresponding to any one keyword combination is 3 or more, a linkage value cannot be added to the corresponding index any longer.

In this case, the user terminal 10 extends the corresponding index by using the index to which the keyword combination is not allocated.

In other words, as shown in FIG. 7A, in the case of adding a new linkage value in a state when the linkage value of the index A[I(i)] is set to EMPTY, (I(j), h(I(j))), I(k), h(I(k))), and 1, the user terminal 10 adds the linkage value of A[I(i)] by using an index A[I(n)] to which the keyword combination is not allocated. At this time, the index to which the keyword combination is not allocated can be verified by the value of b and an index of b=0 is used.

First, the user terminal 10 changes b_{I(n)}=0 of A[I(n)] to b_{I(n)}=1 as shown in FIG. 7B. Further, the user terminal 10 copies and sets I(j), h(I(j))), I(k), and h(I(k)) which are linkage values of A[I(i)] as linkage values of A[I(n)].

Thereafter, as shown in FIG. 7C, the user terminal 10 sets a value of LD_{I(i)} of A[I(i)] to I(n) and sets a value of LK_{I(i)} corresponding to LD_{I(i)} to h(I(n)). Further, values of RD_{I(i)} and RK_{I(i)} are set as ‘EMPTY’. Therefore, A[I(i)] is linked to A[I(n)] and A[I(i)] can be extended.

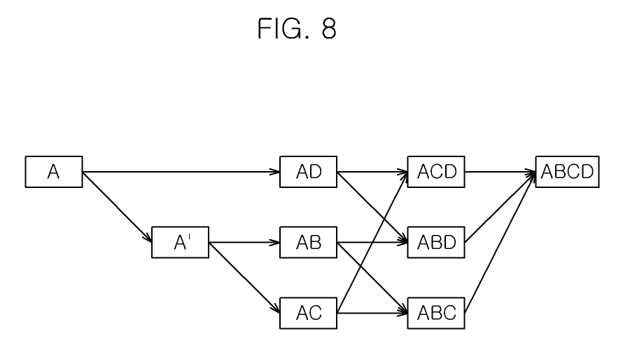

FIG. 8 is an exemplary diagram illustrating a structure of a linked tree of each index according to an embodiment of the present invention. In particular, FIG. 8 illustrates a linked tree structure of an index having a keyword A as a common keyword among a conjunctive keyword of data having keywords A, B, C, and D.

In the embodiment of FIG. 8, it is assumed that an index allocated with a keyword A is represented by ‘Index A’, an index allocated with a conjunctive keyword AB is represented by ‘Index AB’, an index allocated with a conjunctive keyword AC is represented by ‘Index AC’, an index allocated with a conjunctive keyword AD is represented by ‘Index AD’, an index allocated with a conjunctive keyword ABC is represented by ‘Index ABC’, an index allocated with a conjunctive keyword ABD is represented by ‘Index ABD’, an index allocated with a conjunctive keyword ACD is represented by ‘Index ACD’, and an index allocated with a conjunctive keyword ABCD is represented by ‘Index ABCD’. Further, it is assumed that an extensive index of the index A is represented by Index A′.

First, the index A is linked to the index AD including the keyword A. Further, the index A is linked to the index A′ which is the extensive index of the index A. At this time, the index A is linked from the index A′ to the index AB and the index AC.

Further, the index AD is linked to the index ABD and the index ACD including the conjunctive keyword AD and the index AB is linked to the index ABD and the index ABC including the conjunctive keyword AB. Further, the index AC is linked to the index ABC and the index ACD including the conjunctive keyword AC.

Lastly, the index ACD, the index ABD, and the index ABC are linked to the index ABCD including the conjunctive keywords of the corresponding indexes.

Similarly, a linked tree structure starting from the index B, the index C, and the index D is formed in the same manner as above.

The user terminal 10 creates the index table for each data and encrypts each data by using the secret key ‘S’. The encrypted data and index table are transmitted to and stored in the server 20.

Meanwhile, when a plurality of search keywords are selected by a user, the user terminal 10 combines the plurality of selected search keywords at the time of searching the data stored in the server 20. At this time, the user terminal 10 creates a trapdoor for the conjunctive keyword. For example, when the plurality of search keywords are a and b, the user terminal 10 creates ab acquired by combining the search keywords a and b. Herein, ab means ‘a∩b’.

The user terminal 10 creates the trapdoor by using f and h used for encrypting the index at the time of creating the trapdoor for the conjunctive keyword. In other words, the user terminal 10 creates the trapdoor for the conjunctive keyword ab like T=(f(ab), h(ab))=(x, y) At this time, the user terminal 10 transmits the trapdoor T=(x, y) created in the conjunctive keyword to the server 20 and requests data including the conjunctive keyword.

Meanwhile, When the server 20 receives the trapdoor T=(x, y) from the user terminal 10, the server 20 searches the stored index table by using the received trapdoor. Herein, the index table used at the time of searching the index will be described with reference to FIG. 6C.

First, the server 20 extracts an index corresponding to A[x] from x. At this time, since x=f(ab), an index A[f(ab)] corresponding to f(ab) is extracted. Further, since indexes included in the index table are encrypted, an index extracted by using a value of y of the trapdoor is decrypted. At this time, since y=h(ab), the index A[f(ab)] is decrypted by using h(ab).

The server 20 adds a value of ID which is a data identifier of A[f(ab)] to a data search list. For example, when K₁₁=a and K₁₂=b among the keywords of Data1, the server 20 detects and decrypts A[f(K₁₁K₁₂)] to h(K₁₁K₁₂). At this time, when ID which is the data identifier of A[f(K₁₁K₁₂)] is 1, ‘Data1’ is added to the data search list.

Herein, referring to FIG. 6C, A[f(K₁₁K₁₂)] has f(K₁₁K₁₂K₁₃) and h(f(K₁₁K₁₂K₁₃)) which are set as the values of LD and LK. Therefore, the server 20 performs the search even with respect to A[f(K₁₁K₁₂K₁₃)] linked by f(K₁₁K₁₂K₁₃) which is the linkage value of A[f(K₁₁K₁₂)]. At this time, the server 20 decrypts A[f(K₁₁K₁₂K₁₃)] by using the LK value of A[f(K₁₁K₁₂)], that is, h(f(K₁₁K₁₂K₁₃). The server 20 continuously performs the search until all the linkage values have ‘EMPTY’.

Further, when K_{N2}=a and K_{N3}=b among keywords of Data N, the server 20 detects and decrypts A[f(K_{N2}K_{N3})] to h(K_{N2}K_{N3}). At this time, when ID which is the data identifier of A[f(K_{N2}K_{N3})] is N, ‘Data N’ is added to the data search list. The server 20 continuously performs the search even with respect to an index corresponding to linkage values of A[f(K_{N2}K_{N3})].

Herein, according to the embodiment of the present invention, since the index table is created with respect to the conjunctive keyword in addition to the keyword of the data, the server 20 can directly extract the index corresponding to the conjunctive keyword ab from the index table at the time of receiving the trapdoor created from the conjunctive keyword ab. Accordingly, since the server 20 does not need to additionally perform the search for the index including the keyword a or b, it is possible to shorten a search time in comparison with the know data searching method, thereby increasing efficiency.

Meanwhile, when the server 20 completes the search from all the index tables, the server 20 transmits a data search list prepared during the search to the user terminal 10. If the user requests the data of any one of the data search lists, the server 20 extracts and transmits the corresponding data to the user terminal 10.

If even one index having a value of b=0 is searched at the time of performing the search by using the trapdoor, the server 20 stops the search and transmits a message indicating a search failure to the user terminal 10.

As described above, in a method for data encryption and a method for data search using a conjunctive keyword according to an embodiment of the present invention, the configuration and method of the embodiments described as above cannot be limitatively adopted, but the embodiments may be configured by selectively combining all the embodiments or some of the embodiments so that various modifications can be made.

What is claimed is:

1. A method for data encryption using a conjunctive keyword in a portable terminal, comprising:
creating a secret key for data encryption and selecting a one-way function for creating an index table;
combining a plurality of keywords by extracting the plurality of keywords from a corresponding data and configuring the conjunctive keyword from each keyword combination;
allocating the conjunctive keyword in configuring the conjunctive keyword to correspond to a plurality of indexes;
encrypting each conjunctive keyword and an index to which the corresponding conjunctive keyword is allocated by the one-way function selected in selecting the one-way function and creating an index table of the encrypted conjunctive keyword; and
encrypting each data by using the secret key created in selecting the one-way function.

2. The method for data encryption according to claim 1, wherein in selecting the one-way function, two one-way functions are selected and the two one-way functions are a one-way function for encrypting the conjunctive keyword and the other one-way function for encrypting each index to which the conjunctive keyword is allocated.

3. The method for data encryption according to claim 1, wherein the keyword combination corresponds to all partial sets which can be combined from each of the plurality of keywords.

4. The method for data encryption according to claim 1, further comprising: before allocating the conjunctive keyword, creating the plurality of indexes.

5. The method for data encryption according to claim 4, wherein in creating the indexes, 2^{t} indexes are created for t keywords.

6. The method for data encryption according to claim 1, wherein the indexes include at least one of a data identifier, a linkage, and a constant.

7. The method for data encryption according to claim 6, wherein the constant as a discriminator for verifying whether or not the conjunctive keyword is allocated to the corresponding index, has a value of ‘0’ or ‘1’.

8. The method for data encryption according to claim 1, wherein in creating the index table, a linkage value is set for an index including at least one common keyword among the conjunctive keywords allocated to each index.

9. The method for data encryption according to claim 8, wherein in creating the index table, a linkage value is set for a conjunctive keyword that includes at least one common keyword and in which the number of combined keywords is more than the number of at least one common keyword by one.

10. The method for data encryption according to claim 8, wherein the linkage value of each index includes an address value of the corresponding index and a decryption value of the corresponding index.

11. The method for data encryption according to claim 8, wherein in the index table, each index has a linked tree structure by the linkage value set to the index.

12. A method for data search using a conjunctive keyword in a server storing data encrypted by a user terminal and an index table for conjunctive keywords of the encrypted data, comprising:
receiving a trapdoor for a search keyword to which a plurality of keywords are combined from the user terminal;
extracting an index corresponding to the received trapdoor from the index table created for the conjunctive keyword of the data;
decrypting the extracted index by using the trapdoor;
adding a data identifier of the decrypted index to a data search list and performing the data search by extracting a next index from a linkage value of the extracted index; and
transmitting the data search list to the user terminal after the data search using the index table is completed.

13. The method for data search according to claim 12, further comprising:
before receiving the trapdoor, receiving and storing the index table for the encrypted data from the user terminal and the conjunctive keyword of the encrypted data.

14. The method for data search according to claim 13, wherein each index of the index table includes at least one of a data identifier, a linkage, and a constant.

15. The method for data search according to claim 12, wherein the trapdoor includes a conjunctive search keyword encrypted by a one-way function used for encrypting a conjunctive keyword and a hash value encrypted by a one-way function used for encrypting the index in creating the index.

16. The method for data search according to claim 12, wherein in performing the data search, the data search is performed by a linked tree structure from a linkage value of the corresponding index.

17. The method for data search according to claim 12, wherein in performing the data search, the data search is continuously performed until the linkage value of the corresponding index is not provided.

18. The method for data search according to claim 12, wherein performing the data search includes determining whether or not the corresponding index is an index to which the conjunctive keyword is allocated from a value of a constant included in the corresponding index.

19. The method for data search according to claim 18, further comprising:
terminating performing the data search and transmitting an error message to the corresponding user terminal when it is determined that the conjunctive keyword is not allocated to the corresponding index.

20. The method for data search according to claim 12, further comprising:
after transmitting the error message, extracting and transmitting a corresponding data to the corresponding user terminal when the user terminal requests data selected from the data search list.
